(19) United States
(12) Patent Application Publication
(10) Pub. No.: US 2025/0035179 A1
(43) Pub. Date: Jan. 30, 2025

(54) A METHOD OF MANUFACTURING A FRICTION ELEMENT

(71) Applicant: SBS FRICTION A/S, Svendborg (DK)

(72) Inventors: Torben ANDERSEN, Svendborg (DK); Jesper TØNNESEN, Svendborg (DK); Torben MADSEN, Svendborg (DK)

(73) Assignee: SBS FRICTION A/S, Svendborg (DK)

(21) Appl. No.: 18/717,253

(22) PCT Filed: Nov. 7, 2022
(86) PCT No.: PCT/DK2022/050233

§ 371 Date: Jun. 6, 2024

(30) Foreign Application Priority Data
Dec. 8, 2021 (DK) PA 2021 70602

(51) Int. Cl. F16D 69/04; F16D 65/092; F16D 69/02

(52) U.S. Cl. CPC F16D 69/04; F16D 65/092; F16D 69/028; F16D 2069/0458; F16D 2069/0491

(57) ABSTRACT

The present disclosure relates to a method of manufacturing a friction element, the method comprising the steps of providing a back plate, the back plate having a connection surface comprising a plurality of protrusions; providing a sintering composition and applying the sintering composition to the connection surface and shaping the sintering composition to form an intermediary friction element; positioning the intermediary friction elements between a sintering plates; and simultaneously applying a pressure between the sintering plates, the pressure being in the range of 10 kg/cm² to 200 kg/cm²; increasing the temperature to a sintering temperature in the range of 800° C. to 950° C., optionally by applying an electrical current between the sintering plates; and maintaining at least one of the applied pressure, the optionally applied electrical current and the sintering temperature for a sintering duration in the range of 1 hour to 10 hours to form a friction material on the back plate.

### CROSS-REFERENCE TO RELATED APPLICATION

This application is a national stage of International Application No. PCT/DK2022/050233, filed on Nov. 7, 2022, which claims priority to Denmark Application No. PA 2021 70602, filed on Dec. 8, 2021, both of the aforementioned applications are hereby incorporated by reference in their entireties.

### FIELD OF THE DISCLOSURE

The present disclosure relates to a friction element and to a method of manufacturing the friction element. The friction element is useful in a brake system of a vehicle, in particular to a disc brake system, e.g. a disc brake system for a motor bike.

### BACKGROUND

Brake systems employ brake pads to provide friction against a moving component so that the movement can be stopped by pressing the brake pad against the moving component. Brake pads in brake systems are typically located on a carrier plate providing the brake pad with sufficient hardness and stiffness, and the brake pad can consist of a range of different materials, and each material can be manufactured using an appropriate technology. For example, brake pads can be made from ceramic materials, organic materials, e.g. polymers, or from materials of a mainly metallic composition depending on the intended use of the brake pad. For example, brake pads of metallic compositions can be manufactured in sintering processes.

When brake pads are manufactured in a sintering process, a sintering composition is applied to the carrier plate and then subjected to sintering conditions. The sintering composition will typically comprise a base matrix material, abrasives, lubricants, fibres, fillers, and various processing aids. Each of these components can provide functions in the sintering process and to the final brake pad made in the process.

Sintering is appropriate for brake pads to provide low wear, high thermal stability and braking performance, e.g. for motor bikes a strong initial bite to give instant brake feeling, easy modulation and powerful in-stop performance. The present disclosure aims to provide an improved sintering process for manufacturing brake pads.

Sintered brake pads are commonly metal-based brake pads where ductile metals, in particular copper but also nickel, have commonly been used since the ductility provide the brake pad with good brake performance properties, e.g. a desirable friction coefficient, when braking and also further desirable properties. However, both copper and nickel are heavy metals that are unwanted in the environment, and wear of a brake pad containing copper or nickel will inevitably result in release of the metal to the environment.

Several attempts have been made to remove copper from brake pad materials. For example, WO 2017/222538 discloses an alloyed iron-based system for friction applications, which may be substantially copper free. However, a significant amount of tin is required.

EP 0055205 addresses a problem, metal pickup, observed for railroad brakes. In this problem, slivers of wheel steel are transferred to the composition shoes upon braking a train. The problem could be solved by including copper, manganese or ferrochrome in a sintered powder metal friction material for railroad braking.

US 2018/031067 discloses a friction material not comprising more than 0.5 wt % of copper. However, the friction material is not used in a sintering process, so that a manufactured brake pad has a resulting porosity, which is not desirable.

JP 2006-348379 discloses nickel-free sintered metal friction material having wear properties equal to those of a nickel-containing sintered metal friction material. Multiple compositions are disclosed and some of these contain copper whereas other do not contain copper, but the compositions have a special ratio between iron and aluminium.

A sintering process involves at least pressure and temperature applied to the composition being sintered, but many more parameters can be adjusted. U.S. Pat. No. 4,456,578 discloses a method of producing a friction element for a motor car or motorcycle disc brake, where an electric current is applied to the composition being sintered. This process type is generally referred to as conductive sintering or electric current assisted sintering. The compositions for sintering all comprise copper or other environmentally undesirable metals, such as lead.

A further example of conductive sintering of a substrate to provide a friction element is disclosed in U.S. Pat. No. 4,576,872. All substrates tested contain high amounts of copper and in some instances also nickel and lead.

EP 3569672 discloses a sintered metal friction material comprising iron, nickel, zinc, tin, copper and up to 5% of a of sintering assist powder. The sintering assist powder may be iron boride powder, iron phosphide powder, copper phosphide powder or phosphor bronze powder.

CN109253196 discloses a brake friction pair and a preparation method thereof. A brake pad of the brake friction pair comprises a friction material with iron powder, aluminium powder, ferrophosphorus powder, flake graphite, low carbon ferrochromium, zirconium oxide, aluminium oxide and copper powder. The preparation method includes mixing, pressing and sintering.

It is an object of this disclosure to provide an improved sintering process for manufacturing a friction element and also to provide a sintering composition appropriate for the method for manufacturing the friction element. It is a further object to provide a friction element not containing environmentally damaging heavy metals.

### SUMMARY

The present disclosure relates to a method of manufacturing a friction element, the method comprising the steps of providing a back plate, the back plate having a connection surface comprising a plurality of protrusions; providing a sintering composition comprising:
a friction modifying metal in the range of 0 wt % to 5 wt %;
a fibre component in the range of 1 wt % to 10 wt %;
metal phosphide in the range of 2.5 wt % to 12 wt %;
a lubricant in the range of 6 wt % to 23 wt %;
a filler in the range of 0 wt % to 5 wt %;
an abrasive in the range of 3 wt % to 20 wt %;
a processing aid in the range of 0.2 wt % to 2 wt %; and iron to balance;
applying the sintering composition to the connection surface and shaping the sintering composition to form an intermediary friction element having a pre-sintering puck on the back plate; positioning one or more intermediary friction elements between a sintering carrier and a sintering vice plate with the back plate facing the sintering carrier and the pre-sintering puck facing the sintering vice plate or with the back plate facing the sintering vice plate and the pre-sintering puck facing the sintering carrier; and simultaneously applying a pressure between the sintering vice plate and the sintering carrier, the pressure being in the range of 10 kg/cm² to 200 kg/cm²; increasing the temperature between the sintering vice plate and the sintering carrier to a sintering temperature in the range of 800° C. to 950° C.; and maintaining at least one of the applied pressure and the sintering temperature for a sintering duration in the range of 1 hour to 10 hours to form a friction material on the back plate.

In an example, the sintering carrier is a sintering anode, and the sintering vice plate is a sintering cathode, and an electrical current is applied between the sintering cathode and the sintering anode to increase the temperature to the sintering temperature, and at least one of the applied electrical current, the applied pressure, and the sintering temperature is maintained for the sintering duration. For example, the applied electrical current and at least one of the applied pressure and the sintering temperature may be maintained for the sintering duration. Alternatively, the sintering carrier may be a sintering cathode, and the sintering vice plate may be a sintering anode. Thus, for example the method may comprise positioning one or more intermediary friction elements between a sintering anode and a sintering cathode with the back plate facing the sintering anode and the pre-sintering puck facing the sintering cathode or with the back plate facing the sintering cathode and the pre-sintering puck facing the sintering anode; and simultaneously applying a pressure between the sintering cathode and the sintering anode, the pressure being in the range of 10 kg/cm² to 200 kg/cm²; applying an electrical current between the sintering cathode and the sintering anode to increase the temperature to a sintering temperature in the range of 800° C. to 950° C.; and maintaining at least one of the applied pressure, the applied electrical current and the sintering temperature for a sintering duration in the range of 1 hour to 10 hours to form a friction material on the back plate.

In the context of the disclosure, the term “sintering composition” refers to the material subjected to the method to form the friction material. Correspondingly, the term “friction material” refers to the material on the back plate of the friction element manufactured in the method.

The method involves simultaneous application of pressure and a sintering temperature and may also involve application of an electrical current. In the context of this disclosure, this treatment is referred to as “sintering”. When an electrical current is applied, the treatment is referred to as “conductive sintering”. In a sintering process a particulate material is exposed to heat and/or pressure in order to fuse the particles together into a single piece, and in the present context, conductive sintering means that the sintering composition is exposed to a pressure, i.e. a pressure in the range of 10 kg/cm² to 200 kg/cm², and the sintering composition is heated by application of an electrical current. The temperature may also be increased by other means than applying an electrical current, e.g. by heating in an oven or by using heating elements that are not in electrical connection with the intermediary friction element or the sintering stack. The pressure is indicated in the unit kg/cm², although the pressure may also be indicated in other units, e.g. bar or MPa. Calculation of the pressure in bar or MPa from a pressure in kg/cm² is well-known to the skilled person, but in general the pressure is in the range of 0.98 MPa to 19.6 MPa or in the range of 9.8 bar or 196 bar. In the present method, a sintering temperature in the range of 800° C. to 950° C. is selected, and the electrical current is applied so as to increase the temperature to the selected sintering temperature. The sintering anode, the intermediary friction elements, the sintering cathode and any additional components, e.g. further conducting materials, together have a resistance, and the resistance and the relation between the current and the voltage is determined from the resistance. The electrical current, i.e. the combination of the voltage and the current as dependent on the resistance, may be selected freely, but in general, the electrical current is an alternating current at a voltage of up to 400 V and a current of up to 300 A. However, it is also contemplated that the electrical current may have a voltage above 400 V and/or a current above 300 A, and likewise it is also contemplated that the electrical current may be a direct current, e.g. a pulsed direct current. The frequency of the alternating current may be selected freely, but the frequency is typically in the range of 10 Hz to 10 MHz.

The present method employs a sintering carrier and a sintering vice plate. When an electrical current is employed, the sintering carrier is referred to as a sintering anode and the sintering vice plate is referred to as a sintering cathode. Alternatively, the sintering carrier may be a sintering cathode, and the sintering vice plate may be a sintering anode. The sintering anode and the sintering cathode may be referred to collectively as the sintering electrodes, and the terms “anode” and “cathode” are used to differentiate between the electrodes in terms of their relative positioning and the positioning of the intermediary friction element. In particular, an electrical current is applied to the sintering anode and the sintering cathode and the electrical current is not limited to a direct current but may be an alternating current. The sintering anode may also be referred to as the first sintering electrode, and the sintering cathode may also be referred to as the second sintering electrode in the present context. Correspondingly, the sintering carrier and the sintering vice plate may be referred to as “sintering plates”.

The temperature may be increased to the sintering temperature using an external heat source, e.g. using an external heat source without using an electrical current, by the electrical current alone, or the temperature may be increased with a combination of the electrical current and additional external heating, e.g. from an external heat source. In the present context, external heating may be obtained using any external heat source, and the term “external heating” generally refers to heat obtained using any heat source as desired, e.g. the intermediary friction elements or the sintering stack may be placed in an oven or the like, other than by applying an electrical current. Thus, when the method does not employ external heating, the temperature is increased by applying an electrical current between the sintering cathode and the sintering anode. In an example no additional external heating is used. For example, the temperature may be increased, e.g. over ambient temperature, using only the electrical current. In the present context, the ambient temperature is any temperature in the range of 5° C. to 50° C. When the increase in temperature is obtained using only the electrical current and no additional external heating is employed to increase the temperature over ambient temperature, the sintering is easier to control than a sintering process using only external heating or a combination of external heating and heating by an electrical current.

In a preferred example, a plurality of intermediary friction elements is positioned between the sintering plates or between the sintering electrodes, and when sintering electrodes are used, it is preferred that no additional external heating is employed to increase the temperature over ambient temperature. When a plurality of intermediary friction elements is positioned between the sintering electrodes, each of the friction elements in the plurality of intermediary friction elements between will be exposed to identical sintering conditions, since the sintering temperature is obtained from the electrical current passing through the sintering electrodes and thereby also through each of the friction elements. Thereby, it is easier to control the sintering conditions and ensure a production of a plurality of friction elements of the same quality. For example, the plurality of intermediary friction elements may be positioned between the sintering electrodes by having 3 or more rows of intermediary friction elements with each row having three or more intermediary friction elements between the sintering electrodes.

In a particular example, a plurality of intermediary friction elements is positioned in two or more layers in a sintering stack, with each layer being separated by a plate of a conducting material, and heating is obtained using at least an electrical current. By separating the layers with plates of a conducting material it is ensured that all intermediary friction elements receive the same electrical current. A preferred conducting material is a carbon-based material, e.g. graphite. A carbon-based material is electrically conducting but also serves as a thermal barrier, which in turn improves the uniformity of the temperature between different layers in a sintering stack. For example, when the conducting material is a carbon fibre-reinforced carbon, the variation of the temperature in a sintering stack, e.g. between layers in the sintering stack, can be limited to be within 5%, or within 3%, of the selected sintering temperature. Since the temperature is increased to the sintering temperature using an electrical current, each layer is exposed to the same sintering temperature, and each of the intermediary friction elements is exposed to the same sintering conditions. It is especially preferred that no additional external heating is employed to increase the temperature over ambient temperature.

In the present method, at least one of the applied pressure and the sintering temperature is maintained for a sintering duration in the range of 1 hour to 10 hours to form the friction material on the back plate. When an electrical current is employed, the electrical current and at least one of the applied pressure and the sintering temperature are maintained for a sintering duration in the range of 1 hour to 10 hours to form the friction material on the back plate. In general, as long as the temperature is maintained in the range of 800° C. to 950° C., the temperature is considered to be at the sintering temperature. However, the sintering temperature may be any temperature in the range of 800° C. to 950° C., and in an example, a sintering temperature, e.g. 825° C., 850° C., 875° C., 900° C. or 925° C., is selected, and the temperature is considered to be at the sintering temperature as long as the temperature is within 50° C. of the selected sintering temperature. The temperature is preferably increased to the sintering temperature by the electrical current without additional external heating, and it is preferred that the applied electrical current and the pressure are maintained for the sintering duration. In the present context, the sintering duration starts when the sintering temperature has been reached. For example, the pressure may be applied when the temperature is at ambient temperature and before the temperature is increased, e.g. using the electrical current, and maintained at the start of and during the sintering duration. In a specific example, the temperature is increased to the sintering temperature by the electrical current without additional external heating, and once the sintering temperature, e.g. the selected sintering temperature, has been reached, the electrical current is adjusted to maintain the temperature at the sintering temperature. For example, the temperature may be monitored, and the electrical current may be adjusted in a feed-back loop to maintain the temperature at the sintering temperature, e.g. the selected sintering temperature ±50° C., 40° C., 30° C., 25° C., ±20° C., +15° C., 10° C., or ±5° C. At the end of the sintering duration, the temperature is decreased to ambient temperature. In general, the pressure is maintained until the temperature has reached a predefined temperature limit, e.g. a temperature below 200° C.

The friction element comprises a back plate and a friction material, and the friction element is useful in a brake system of a vehicle, where the friction material of the friction element is pressed against a rotating rotor to cause friction and thereby stopping the rotation of the rotor, although the friction element may also be used to prevent rotation of a stationary rotor. The rotor is typically in the shape of an annulus. It is also contemplated that the rotor may be in the shape of a disc. The annulus or disc has a centre with an axis, and the annulus or disc may be in a plane normal to the axis. The annulus can generally be described by two concentric curves, e.g. the annulus can be described by two concentric circles, and the disc can likewise be described as a curved around a centre. The annulus has an inner surface and an outer surface in the plane normal to the axis of the annulus.

The friction element will generally be mounted in a brake system to maximise the area of contact between the friction material and the inner surface of the rotor or the outer surface of the rotor when the brake system is activated to stop the rotation of the rotor. A brake system may also contain two friction elements where one is mounted for the friction material to be pressed against the inner surface of the rotor, and the other is mounted for the friction material to be pressed against the outer surface of the rotor. In particular, the two friction elements may be mounted at the same location in the plane normal to the axis of the annulus.

The rotor has a rotational direction, and the dimensions of the friction element can also be defined relative to the rotational direction. Thus, the friction element and therefore also the back plate have a “front end” and a “rear end” defined by the rotational direction, where the direction from the front end to the back end defines a braking direction of the friction element. The rotational direction is described in the perimeter of a circle, whereas the braking direction is a straight line so that the braking direction does not overlap with the rotational direction. However, the rotational direction will also define a tangential rotational direction, and in general, the braking direction does not deviate more than 20° from the tangential rotational direction depending on the diameter of the rotor.

In the method, a sintering composition is applied to the connection surface of the back plate. The sintering composition in summarised in Table 1.

TABLE 1
The sintering component

| | | Minimum | Maximum |
|---|---|---|---|
| | Example of | amount | amount |
| Component | component | (wt %) | (wt %) |
| Friction modifying | Tin, copper, nickel, | 0 | 5 |
| metal | lead | | |
| Fibre component | Steel fibre | 1 | 10 |
| Metal phosphide | Iron phosphide | 2.5 | 12 |
| Lubricant | Graphite | 6 | 23 |
| Filler | Non-graphite | 0 | 5 |
| | carbon | | |
| Abrasive | Metal oxides | 3 | 20 |
| Processing aid | Paraffinic oil | 0.2 | 2 |
| Iron | | to balance | to balance |

All components of the sintering composition are provided as a percentage (wt %) based on the weight of the sintering composition. Table 1 indicates exemplary components but it is to be understood that for each component, any number of specific components may be used. For example, the friction modifying metal may comprise one or more different metals, and the lubricant may comprise one or more different lubricant components, etc. In the context of the disclosure, the weight is the dry weight for solid components and for liquid components the weight of the component under ambient conditions. The weight may also be referred to as the mass. Upon sintering, the processing aid will be lost, and the relative contents will be adjusted accordingly.

Except for liquid components, all components are provided as powders. The powders are generally micro-sized, e.g. the particles have a size in the range of 1 μm to 1000 μm, and the particles may have any distribution of size and shape. In general, particles for use in the present method are subjected to size fractionation, e.g. sieving, prior to use in the method, and the particles are typically classified only with an upper limit of the size range. However, it is to be understood that particles used in the present method have a lower limit of size of 1 μm, unless stated otherwise. Moreover, the size fractionation may also involve removal of small particles so that the particles used are the size fraction where both large and small particles have been removed, e.g. the size may be in the range of 1 μm to 1000 μm. Prior to applying the sintering composition to the back plate, the sintering composition should be well mixed.

The sintering composition comprises iron, which provides a metallic matrix, and the metallic matrix is the main component of the sintering composition. In general, the sintering composition comprises at least 40 wt % iron, such as at least 45 wt %, such as at least 50 wt % iron, such as at least 55 wt %, or at least 60 wt % iron. The iron is typically at least 99% pure iron, although it is also contemplated that the iron contains further metals or other alloying elements. The metallic matrix is provided as particles, which may have any shape, e.g. the particles may be generally spherical. For example, the metallic matrix may be iron particles of a median size in the range of 80 μm to 120 μm and of a narrow size distribution. The iron particles of the metallic matrix preferably have a rough surface with a concomitantly high specific surface area, e.g. as classified using N₂-adsorption according to the Brunauer-Emmett-Teller (BET) adsorption method. For example, the iron particles may have a specific surface area, e.g. a BET specific surface area, of at least 50 m²/kg, such at least 75 m²/kg, or at least 100 m²/kg. Without being bound by theory the present inventors believe that a specific surface area of at least 50 m²/kg will provide better contact with the iron particles and the other particulate components of the sintering composition and also the connection surface of the back plate, to provide a better integration of the pre-sintering puck with the protrusions on the connection surface. This effect is increased upon increasing the specific surface area of the iron particles, e.g. to 100 m²/kg or more. The effect of the high specific surface area is in turn believed to provide excellent braking performance even when the sintering composition does not comprise copper or nickel. It is further believed that for iron particles with a high specific surface area, the high specific surface area improves mixing between the iron particle and the lubricant.

The sintering composition comprises a fibre component. In general, the fibre component is a fibrous material that will remain fibrous during the conductive sintering, and any appropriate fibrous material may be used as the fibre component. Exemplary fibre components include metal fibres, e.g. steel fibres, brass fibres, bronze fibres, mineral fibres, ceramic fibres, e.g. silicon carbide fibres or other carbide fibres, silicon oxide fibres, aluminium oxide fibres, or other metal oxide fibres, and their mixtures and combinations. The fibre component can generally be described as a powder, and the particles of the fibre component are generally rod shaped with a length in the range of 50 μm to 500 μm, e.g. 100 μm to 300 μm, and a thickness and width in the range of 1 μm to 50 μm.

The sintering composition may comprise a friction modifying metal, e.g. in the range of 1 wt % to 5 wt %. Any metal having a high ductility and/or being soft may be used as the friction modifying metal. Combinations of metals, e.g. alloys of friction modifying metals, may also be used, although it is preferred that the friction modifying metal does not comprise alloying components. However, particles of different friction modifying metals may be mixed and added to the sintering composition without alloying the different friction modifying metals. The present inventors believe that alloying components in the friction modifying metal will reduce the ductility and therefore friction modifying metals without alloying components provide a better effect on the braking performance. Exemplary friction modifying metals are tin, copper, nickel and lead, and their mixtures and combinations, but other friction modifying metals are known in the art. However, it is preferred that the copper and nickel are not used as friction modifying metals. Moreover, aluminium is generally not useful as a friction modifying metal. It is preferred that the sintering composition does not comprise aluminium, i.e. metallic aluminium. A particularly preferred friction modifying metal is tin. The friction modifying metal is preferably used as particles with sizes in the range of 50 μm to 200 μm, e.g. 80 μm to 100 μm. In general, the friction modifying metal particles should be smaller than the iron particles of the metallic matrix. Thereby, a better distribution of the friction modifying metal particles in the iron particles of the metallic matrix is obtained. It is particularly preferred to use a friction modifying metal, e.g. tin, having a melting point below the sintering temperature. When a friction modifying metal having a melting point below the sintering temperature, e.g. tin or lead, is used in the method, an optimal distribution of the friction modifying metal in the friction material is obtained in the sintering process, which provides an improved breaking performance for the friction element, which is not available, when the friction modifying metal does not melt in the sintering process, i.e. when the friction modifying metal is copper and nickel. Without being bound by theory, the present inventors believe that upon melting, the molten friction modifying metal distributes on the surface of the iron particles of the metallic matrix, and it is therefore preferred to use iron particles having a high specific surface area, e.g. a BET specific surface area of at least 50 m²/kg, in particular of at least 100 m²/kg. The distribution of the molten friction modifying metal on the surface area of the iron particles having a high specific surface area is believed to provide improved braking performance of the friction material. Thus, in an example the iron particles have a high specific surface area, e.g. a BET specific surface area of at least 50 m²/kg, in particular of at least 100 m²/kg, and the friction modifying metal, e.g. tin, has a melting point below the sintering temperature.

The sintering composition comprises a metal phosphide. In the present context, a metal phosphide is a chemical compound of a metal and phosphorus, e.g. with the metal and the phosphorous atoms being in ionic form. Thus, the metal phosphide provided to the sintering composition preferably does not contain phosphorous that is not in compound form with the metal. For iron phosphide, the compound form may be denoted Fe₂P or Fe₃P. It is particularly preferred that iron phosphide, when used, is not in the form commonly referred to as ferrophosphorus. In an example, the sintering composition does not comprise ferrophosphorus. In particular, ferrophosphorus contains unwanted contaminations that negatively effect the control of the manufacturing method so that when ferrophosphorus is included in the sintering composition, the effect otherwise intended by using a metal phosphide cannot be obtained.

The present inventors have surprisingly found that metal phosphides are particularly useful sintering aids in a sintering process in the manufacture of a friction material, and that the metal phosphides allow that the friction modifying metal may be used in a low amount, i.e. up to 5 wt %, e.g. in the range of 0.5 wt % to 1.5 wt % or 1 wt % to 1.4 wt %, while still providing sufficient braking characteristics to the manufactured friction element. Without being bound by theory, the present inventors believe that the phosphorous atom of the metal phosphide diffuses into the iron matrix upon heating to the sintering temperature and creates localised regions with phosphorous, which are advantageous for the braking characteristics of the friction element. The localised regions with phosphorous may also be referred to as “phosphorous containing alloys” or “phosphorous containing mixtures”. This effect is especially pronounced when conductive sintering is employed, where, without being bound by theory, the present inventors believe that the electrical current interacts with the phosphorous of the metal phosphide to further increase the diffusion of the phosphorous atom, especially in the phosphide form, to make the effect of the metal phosphide even more pronounced than when heating is employed without using an electrical current. This effect is considered to be especially pronounced when the friction modifying metal melts during the sintering, and it is therefore preferred that the friction modifying metal has a melting point lower than the sintering temperature. It is even more preferred that an electrical current is applied to increase the temperature to the sintering temperature. However, this effect is also considered to be obtained when other friction modifying metals are used. Thus, the sintering composition comprises a metal phosphide in the range of 2.5 wt % to 12 wt % of the sintering composition, e.g. at least 4 wt % and up to 12 wt %, such as in the range of 5 wt % to 10 wt %, 6 wt % to 9 wt % or 7 wt % to 8 wt %. The metal phosphide may be an alkaline earth metal phosphide, a transition metal phosphide, a combination or mixture of one or more alkaline earth metal phosphides, a combination or mixture of one or more transition metal phosphides, or a combination or mixture of alkaline earth metal phosphides and one or more transition metal phosphides. Exemplary metal phosphides are iron phosphide and copper phosphide, in particular a phosphide of a metal contained in another form in the sintering composition. The metal phosphide may be present in particulate form with particles having sizes in the range of 1 μm to 500 μm, e.g. 100 μm to 200 μm.

The present inventors have surprisingly found that when the friction modifying metal has a melting point below the sintering temperature and when an electrical current is applied between the sintering cathode and the sintering anode, the distribution of the friction modifying metal is improved further, which in turn allows that the friction modifying metal is used in an amount at or below 1.5 wt % while still providing the friction effect of the friction modifying metal to the friction material. Thus, in an example the friction modifying metal has a melting point below the sintering temperature, e.g. the friction modifying metal is tin, and is present in the sintering composition in the range of 1 wt % to 1.4 wt %. In particular, the friction modifying metal, e.g. tin, may be present as particles having a size in the range of 80 μm to 100 μm. It is further preferred that the iron particles have a BET specific surface area of at least 50 m²/kg, in particular of at least 100 m²/kg.

It is also contemplated that the sintering composition does not require a friction modifying metal. When the sintering composition does comprise a friction modifying metal, the contents of the other components are adjusted accordingly, and exemplary sintering compositions are disclosed in Table 2.

TABLE 2
The sintering composition without a friction modifying metal

| | | Minimum | Maximum |
|---|---|---|---|
| | Example of | amount | amount |
| Component | component | (wt %) | (wt %) |
| Friction modifying | | Not | Not |
| metal | | present | present |
| Fibre component | Steel fibre | 1 | 10 |
| Metal phosphide | Iron phosphide | 2.5 | 12 |
| Lubricant | Graphite | 6 | 23 |
| Filler | Non-graphite | 0 | 5 |
| | carbon | | |
| Abrasive | Metal oxides | 3 | 20 |
| Processing aid | Paraffinic oil | 0.2 | 2 |
| Iron | | to balance | to balance |

Without being bound by theory, the present inventors believe that the metal phosphide, e.g. when present in the range of 4 wt % to 12 wt %, e.g. 5 wt % to 12 wt % or 6 wt % to 12 wt %, allows that a friction element, e.g. a brake pad, manufactured without a friction modifying metal in the method of the invention obtains appropriate braking characteristics. This is especially relevant when the method involves conductive sintering.

The sintering composition comprises a lubricant, in particular a solid lubricant. Any solid lubricant known in the art may be used in the sintering composition. Exemplary solid lubricants are graphite and metal sulphides, e.g. tungsten disulphide and molybdenum disulphide. It is also contemplated to employ mixtures and combinations of different lubricants. A preferred lubricant is a graphite-based lubricant. The sintering composition may thus comprise a graphite component. In graphite, the carbon atoms are arranged in a hexagonal structure, which is considered to provide the lubricating effect, and graphite is a preferred lubricant. The lubricant is preferably used as particles. For example, the lubricant may be graphite particles with sizes in the range of 100 μm to 600 μm, e.g. with a median size in the range of 150 μm to 350 μm. Metal sulphides, e.g. tungsten disulphide and molybdenum disulphide, are typically smaller than graphite particles. For example, the lubricant may be particles of tungsten disulphide or molybdenum disulphide having sizes less than 100 μm, e.g. up to 60 μm, e.g. in the range of 10 μm to 60 μm. The lubricant is present in an amount in the range of 6 wt % to 23 wt % of the sintering composition, e.g. in the range of 13 wt % to 19 wt %.

The sintering composition may further comprise a filler. Any filler known in the art may be used in the sintering composition. Exemplary fillers are non-graphite carbon, diatomaceous earth, ashes, metal fluorides, metal sulphates and their combinations. The filler is typically particles having a size in the range of 50 μm to 200 μm. The filler may be present in an amount in the range of 1 wt % to 5 wt % of the sintering composition. Non-graphite carbon components may also be referred to as “coke” or “carbon black”.

The sintering composition comprises an abrasive present in an amount in the range of 3 wt % to 20 wt % of the sintering composition, e.g. in the range of 10 wt % to 15 wt %. The abrasive comprises particles of oxides, carbides or nitrides of metals and/or metalloids, and their mixtures and combinations. Thus, for example the abrasive may comprise oxides of aluminium, silicon, and zirconium, or carbides of silicon and their combinations. However, other abrasives are readily available to the skilled person. In particular, abrasives may be classified based on the hardness of the material of the abrasive, and a material of a limited hardness may be a filler or an abrasive in the present context. For example, metal fluorides and metal sulphates may be used in the present sintering composition, where they may be considered as fillers or abrasives. In general, the total amount of filler and abrasive is thus in the range of 6 wt % and 28 wt %. For example, the sintering composition may comprise an abrasive present in the range of 6 wt % and 28 wt %, which abrasive is selected from metal oxides, metal carbides, metal fluorides, metal sulphates and combinations thereof. In an example, the abrasive comprises aluminium oxide, e.g. aluminium oxide particles with sizes in the range of 10 μm to 30 μm, silicon oxide, e.g. silicon oxide particles with sizes in the range of 20 μm to 50 μm and/or 100 μm to 200 μm, and zirconium oxide, e.g. zirconium oxide particles with sizes in the range of 50 μm to 150 μm. The oxides may be a pure oxide or a mixed oxide, e.g. a mixed oxide of zirconium and silicon, e.g. with zirconium oxide constituting at least 50 wt % of the mixed oxide. For example, the lubricant may be a naturally occurring mineral oxide, e.g. a mineral oxide comprising zirconium and silicon as the main non-oxygen components but optionally also other non-oxygen components, such as hafnium, iron, titanium, and other components.

The powdery components of the sintering composition are mixed, and in order to aid the mixing a processing aid, e.g. a liquid that will evaporate during the conductive sintering, is added in the amount of 0.2 wt % to 2 wt % of the dry weight of the sintering composition, e.g. in the amount of 0.6 wt % to 1 wt %. When the processing aid has been added to the sintering composition, the sintering composition may also be referred to as a sintering mixture in the context of this disclosure. Any processing aid known in the field may be used, but the processing aid is preferably a mineral oil, e.g. a paraffin oil with 8 to 16 carbon chain alkanes or cycloalkanes, in particular alkanes with 10 to 13 carbon atoms. Upon heating, e.g. in the process of increasing the temperature to the sintering temperature or at least at the sintering temperature, the processing aid will evaporate from the sintering composition.

The back plate and the friction material each have a thickness, and the thickness of back plate and the friction material depends on the intended use of the friction element. For example, the heavier the vehicle where a brake system is to be used the thicker the friction element, and especially the friction material. For example, for a disc brake system for a motor bike, the thickness of the back plate is typically in the range of 1 mm to 10 mm, e.g. 2 mm to 5 mm. The thickness of the friction material is typically in the range of 1 mm to 15 mm, e.g. 2 mm to 10 mm. Other relevant vehicles are electric bicycles, e.g. electric mountain bikes or electric cargo bikes, all-terrain vehicles (ATV), and utility task vehicles (UTV).

The friction material has a length in the braking direction between the front end and the rear end of the back plate, and a width generally defined by the two concentric curves of an annulus, when the rotor has the shape of an annulus. The length of the friction material is typically in the range of 20 mm to 150 mm when the friction element is to be used in a disc brake system for a motor bike, and the width of the friction material is typically in the range of 20 mm to100 mm.

The friction material of the friction element is prepared in a sintering process, and the material of the back plate can be selected to withstand the temperature used in the sintering process. The sintering process involves applying an electric current to a sintering stack, and the back plate should therefore be electrically conducting. The back plate may also be referred to as an electrically conducting back plate. For example, the back plate made be made from a metal, a ceramic material or composite of a metal and a ceramic material. In addition, the back plate may have a coating, e.g. a metallic coating, regardless of the material of the back plate. For example, the back plate may be made of an alloy, such as steel, stainless steel, brass, or bronze, which may further be coated with another metal, e.g. zinc. A preferred alloy is a hot-rolled steel, e.g. any steel as described in European standard EN 10025. The hot-rolled steel may also be referred to as a low carbon manganese steel. The present inventors have surprisingly found that when the back plate is made from hot-rolled structural steel, an especially tight integration of the friction material with the back plate is provided in the conductive sintering process of this disclosure. In particular, when the voltage is in the range of 0 V to 400 V and the current is in the range of 0 A to 300 A, a tighter integration with the back plate is obtained. Without being bound by theory, the inventors believe that the thermal expansion coefficient coupled with the electrical conductivity of the hot-rolled structural steel and the composition of the friction material provide a tighter integration.

The back plate has a connection surface comprising a plurality of protrusions. The protrusions extend from the connection surface and form an angle with the connection surface. The angle is preferably defined in the braking direction of the friction element, and the angle can be defined from the front end of the back plate to be in the range of 20° to 160°, e.g. the angle may be in the range of 60° to 120°, such as 80° to 100°. In an example, the angle is about 90°. When the angle is in the range of 60° to 80°, the friction material is more tightly integrated with the back plate than when the angle is outside this range.

The connection surface of the back plate comprises a plurality of protrusions. It is preferred that the protrusions are arranged in rows in the braking direction, and the connection surface comprise a plurality of rows of protrusions in the direction normal to the braking direction. It is particularly preferred that the positions of the plurality of protrusions in one row in the braking direction are staggered compared to plurality of protrusions in a neighbouring row in the braking direction. Thus, in an example, the connection surface has plurality of parallel rows in the braking direction, which rows are preferably staggered. By having staggered rows of protrusions in the connection surface an improved integration of the metallic matrix with the back plate is obtained in the sintering process.

In general, each protrusion has a width normal to the braking direction in the range of 20% to 100% of the thickness of the friction material. The width in the braking direction may also be in the range of 20% to 100% of the thickness of the friction material, although in an example, the width in the braking direction is smaller than the width in the direction normal to the braking direction.

The protrusions extend from the connection surface to have a length from the connection surface. The length of the protrusion is typically in the range of 50% to 80% of the thickness of the friction material, although the length may also be outside this range. When the lengths of the protrusions are in the range of 50% to 80% of the thickness of the friction material, and particular also when the angles of the protrusions are in the range of 60° to 120°, especially 80° to 100°, an improved integration of the metallic matrix with the connection surface is obtained in the sintering process.

In an example, the connection surface comprises a trench extending from a protrusion in the braking direction. The connection surface preferably has a trench for a plurality of the protrusions, in particular a trench for each protrusion. The trench may extend from the protrusion toward the front end or toward the rear end of the back plate, e.g. in the braking direction or in a direction opposite to the braking direction. Each trench generally has a depth in the range of 10% to 30% of the thickness of the friction material, and each trench has a length, as calculated from the affiliated protrusion in the range of 50% to 80% of the length of the affiliated protrusion. The trenches may have any shape, but in a specific example the trenches have a triangular shape in the connection surface with the wider end adjacent to the affiliated protrusion and the narrow end pointing toward the front end or the rear end of the back plate. It is preferred that the connection surface contains a trench for each protrusion, and further that the plurality of protrusions is arranged in staggered rows in the braking direction. In a further example, the connection surface has a first plurality of rows of protrusions in the braking direction with a trench extending from each protrusion toward the front end of the back plate and a second plurality of rows of protrusions in the braking direction with a trench extending from each protrusion toward the rear end of the back plate with rows of the first and the second plurality alternating in the direction normal to the braking direction.

When the connection surface of the back plate contains trenches in addition to the protrusions, the iron particles of the metallic matrix will fill the trench, and since the sintering composition contains iron phosphide, the electric current in the sintering process will aid in integrating the metallic matrix more efficiently with the connection surface. Thereby, a stronger integration of the friction material is obtained when the connection surface has trenches.

The protrusions of the back plate are preferably made from the same material as the back plate. In an example, the method comprises providing a back plate made from a metal or an alloy, such as steel, stainless steel, brass, or bronze, and cutting a plurality of trenches in the connection surface. The cutting is started at a vertex point in the connection surface, and the cutting tool moved toward the rear end or the front end of the back plate while cutting the trench. The trench is cut from the vertex point with the width and the depth increasing to a protrusion site, where the cutting is stopped. Thereby, at triangular trench is provided in the connection surface between the vertex point and the protrusion site. The metal of the connection surface remains attached to the connection surface at the protrusion site, and by bending the metal, a protrusion will be formed at the protrusion site, so that a protrusion with an affiliated trench is formed. It is preferred that multiple trenches are cut in the connection surface in the braking direction, and it is further preferred that a plurality of rows, each with a plurality of trenches, is cut, e.g. is cut simultaneously, in the braking direction of the back plate. It is even more preferred that pluralities of trenches are cut from the front end toward the rear end of the back plate and that pluralities of trenches are cut from the rear end toward the front end of the back plate. Thus, the connection surface may have a first plurality of rows of protrusions in the braking direction with a trench extending from each protrusion toward the front end of the back plate and a second plurality of rows of protrusions in the braking direction with a trench extending from each protrusion toward the rear end of the back plate with rows of the first and the second plurality alternating in the direction normal to the braking direction.

The protrusion thus formed preferably has an angle in the range of 60⁰ to 120°, e.g. 80° to 100°, and each protrusion may vary in shape, e.g. the protrusions may be straight, or bent or have the shape of a hook. Moreover, the cutting procedure results in rough surfaces of the trenches and especially also the protrusions, and the present inventors have surprisingly found that rough surfaces and the varying shapes of the protrusions as well as the trenches allow that a tighter interaction between the metallic matrix and the connection surface is obtained in the sintering process. This is even more pronounced when the connection surface is cut to have a plurality of staggered trenches as described above. Without being bound by theory, the present inventors believe that the rough surfaces provide a better contact between the metallic matrix and the material of the back plate thus resulting in better integration of the friction material with the connection surface. The effect is still further pronounced by including iron phosphide in the sintering composition and applying an electric current during sintering.

The sintering mixture is applied to the connection surface of the back plate, and the sintering mixture is shaped to form an intermediary friction element having a pre-sintering puck on the back plate. The shaping may be effected by subjecting the sintering mixture on the back plate to a pressure in the range of 300 kg/cm² to 3300 kg/cm², or in the range of 29 MPa to 324 MPa, or 294 bar to 3236 bar. The pressure is typically maintained for a shaping duration of at least 10 seconds, e.g. a shaping duration in the range of seconds to 10 minutes. When the sintering composition comprises a friction modifying metal having a melting point below the sintering temperature, it is preferred that the temperature in the shaping step is below the melting point of the friction modifying metal.

It is further preferred that the conductive sintering is performed in a chamber or furnace or the like, where the atmosphere can be controlled. The conductive sintering may be performed in a lowered pressure compared to the ambient pressure, e.g. in a vacuum, and/or that the composition of the atmosphere is controlled, e.g. to an oxidatively inert atmosphere, such as an atmosphere of H₂ in N₂, e.g. 5 vol % H₂, 95 vol % N₂.

Any embodiment of the disclosure may be used in any aspect of the disclosure, and any advantage for a specific embodiment applies equally when an embodiment is used in a specific aspect.

### BRIEF DESCRIPTION OF THE DRAWINGS

In the following the disclosure will be explained in greater detail with the aid of an example and with reference to the schematic drawings, in which

FIG. 1 shows a friction element of the present disclosure;

FIG. 2 shows a photo of a motorcycle wheel with a brake having a friction element of the present disclosure;

FIG. 3 shows a back plate for the manufacture of a friction element of the present disclosure;

FIG. 4 shows an intermediary friction element of the present disclosure;

FIG. 5 shows a sintering stack of the present disclosure;

FIG. 6 shows a temperature profile of an embodiment of the present disclosure.

The disclosure is not limited to the embodiment/s illustrated in the drawings. Accordingly, it should be understood that where features mentioned in the appended claims are followed by reference signs, such signs are included solely for the purpose of enhancing the intelligibility of the claims and are in no way limiting on the scope of the claims

### DETAILED DESCRIPTION

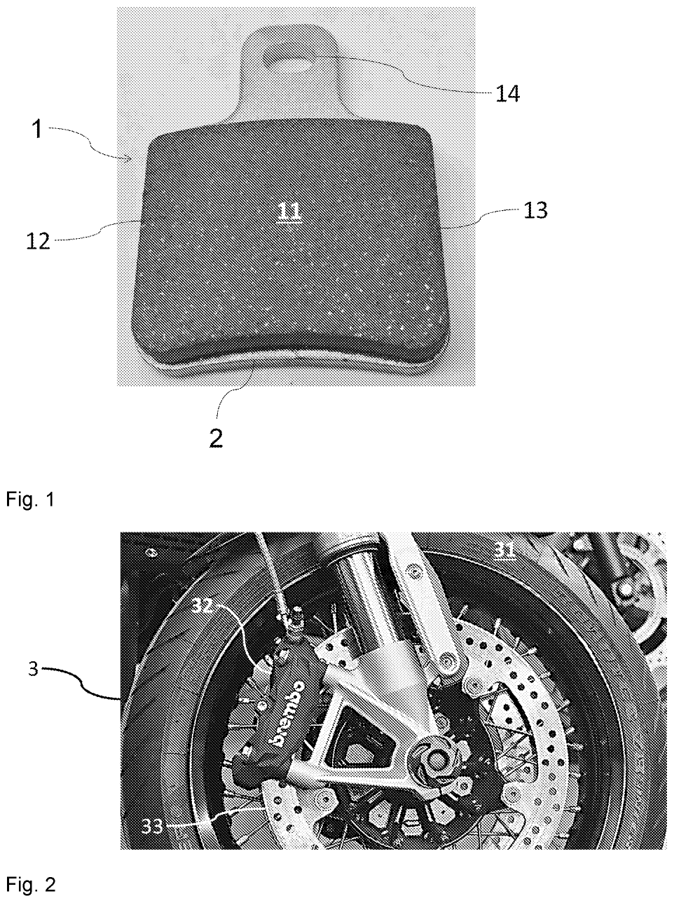

The present disclosure relates to a method of manufacturing a friction element 1 and shown in FIG. 1. The friction element 1 has a back plate 2 and a friction material 11. FIG. 2 shows a photo of a motorcycle wheel 3 with a brake assembly 32 having the friction element 1. Thus, FIG. 2 shows a wheel 3 with a tire 31 and a brake assembly 32. The friction element 1 is not visible in FIG. 2 but is located in the brake assembly 32. The friction element 11 in the brake assembly 32 is to be pressed against a rotor 33, when the rotor 33 is rotating to cause friction and thereby stopping the rotation of the rotor 33. The friction element 1 and the back plate 2 have a front end 12 and a rear end 13 defined by the rotational direction of a rotor 33 for which the friction material 11 is to be used.

The friction element 1 may be tested using any standard test. For example, the friction element 1 may be subjected to a shear test according to ISO 6312 or a compressibility test according to ISO 6310. ISO 6312 generally analyses the strength of the bond connection between a lining material and a carrier in a disc brake pad assembly or a drum brake shoe assembly. ISO 6310 generally analyses the compressive displacement of brake linings or brake pad assemblies due to loading and temperature and also the lining thermal swell and growth. Brake pads, such as the friction element 1, may be analysed in a dynamometer test. For example, the SAE J2522 test (defined by the Society of Automotive Engineers, SAE International) assesses the effectiveness behaviour of a friction material with regard to pressure, temperature and speed for motor vehicles fitted with hydraulic brake actuation. The main purpose of SAE J2522 is to compare friction materials under equal conditions thereby allowing comparison of tested brake pads.

### Example 1

A sintering composition was prepared by mixing powders of a friction modifying metal, a fibre component, a metal phosphide, a lubricant, a filler, an abrasive, a processing aid and iron to balance. Specifically, the sintering composition comprised 58 wt % iron powder, and the friction metal was tin, which was present at 1.2 wt %. The iron powder had a median particle size of about 90 μm, and the specific surface area, as determined using N₂-adsorption according to the Brunauer-Emmett-Teller (BET) adsorption method, was about 75 m²/kg. The tin was obtained as particles having a median size of about 80 μm. The tin particles were generally non-porous. The mixture was provided with about 5 wt % iron phosphide.

Graphite particles having a median size of about 200 μm were added at about 15 wt % as a lubricant.

Mineral zircon particles with a median size of about 100 μm were used as an abrasive at about 12 wt %.

A diatomaceous earth was provided an applied without further modification at 3 wt % as a filler.

Steel fibres having an average length of about 200 μm and a width of about 25 μm were added at about 5 wt %.

The powdery components were mixed before addition of 1 wt % paraffin oil as a processing aid, and the components including the paraffin oil were mixed thoroughly.

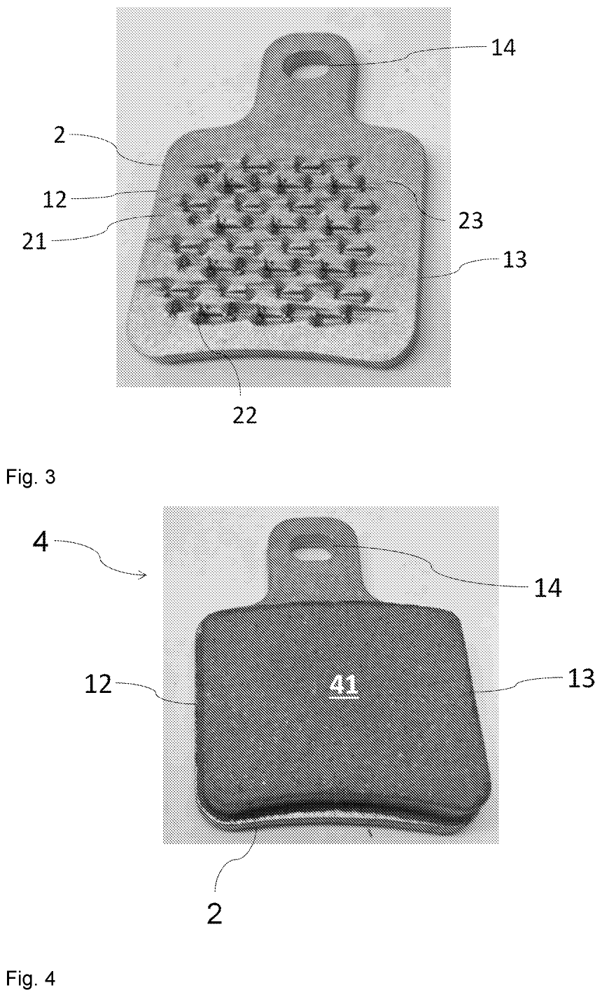

A back plate 2, as shown in FIG. 3, made from a hot-rolled low carbon manganese steel was provided. The back plate 2 had a thickness of about 4 mm and dimensions of 4 cm by 4 cm and contained a mounting ring 14. The back plate 2 defined the front end 12 and the rear end 13 of the friction element 1 eventually manufactured in the method, see also FIG. 1.

The connection surface 21 was provided by protrusions 22 by cutting trenches 23 into the connection surface 21, so that the connection surface 21 had trenches 23 of a generally triangular shape with the wider end adjacent to the affiliated protrusion 22 and the narrow end pointing toward the front end 12 or the rear end 13 of the back plate 2. The protrusions 22 extended from the connection surface 21 at an approximately right angle.

The sintering composition was applied to the connection surface 21 as a layer of about 4 mm thickness, and the back plate 2 with the sintering composition was applied in a vice and pressurised at about 2000 kg/cm² for a shaping duration of about 2 minutes to form an intermediary friction element 4 with a pre-sintering puck 41 as shown in FIG. 4.

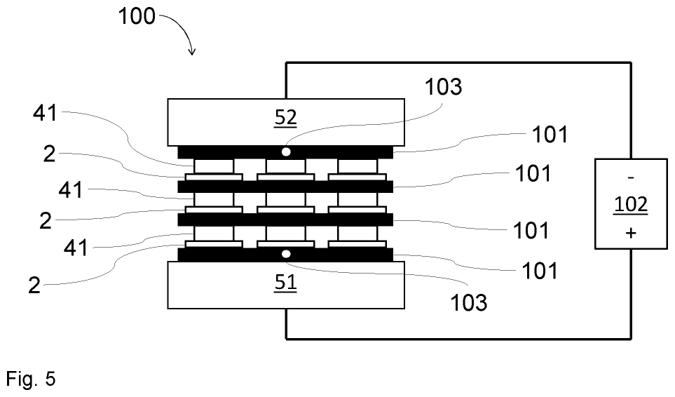

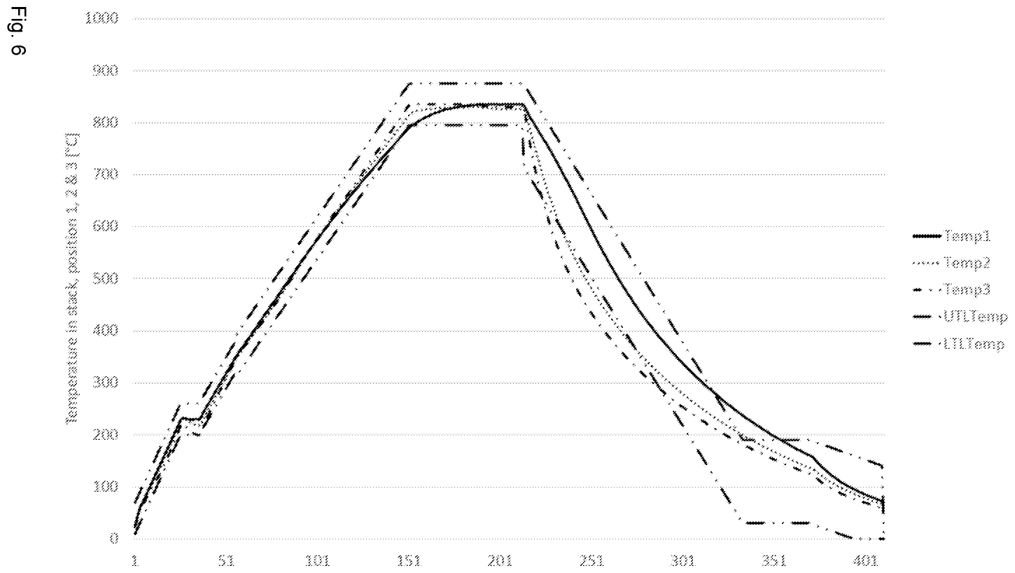

The intermediary friction element 4 was applied in a sintering stack 100. A schematic drawing of a sintering stack 100 is shown in FIG. 5 with a plurality of intermediary friction elements 4. FIG. 5 is not drawn to scale. Specifically, four rows each having six intermediary friction elements 4 were applied to the sintering anode 51 with carbon fibre-reinforced carbon (CFC) as a conducting material 101, and a further layer of CFC as a conducting material 101, and yet a further layer of intermediary friction elements 4 was applied to the conducting material 101. The conducting material 101 had a thickness of about 3 cm. The sintering stack 100 contained a total of 10 layers of intermediary friction elements 4 separated by layers of CFC as a conducting material 101. The pressure between the sintering anode 51 and the sintering cathode 52, and thereby the pressure of the intermediary friction elements 4, was set to 100 kg/cm².

The sintering anode 51 and the sintering cathode 52 were electrically connected to a power supply 102. In FIG. 5, the power supply 102 is shown with a + and a −, but the power supply 102 could provide a direct current, a pulsed direct current or an alternating current. The sintering stack 100 contained three thermocouples 103; FIG. 5 shows two thermocouples 103 but it is to be understood that any number of thermocouples 103 may be used in a specific sintering stack 100. Specifically, the middle conducting material 101 in the sintering stack 100 contained a thermocouple 103, and two further thermocouples were used near the sintering anode 51 and the sintering cathode 52, respectively. The thermocouples 103 were electrically connected to the power supply 102 and a data processing unit (not shown) to define a feedback loop for controlling the power of the power supply 102 from the temperatures recorded from the thermocouples 103.

The sintering stack was enclosed in a cabinet with a gas inlet and a gas outlet for controlling the atmosphere in the cabinet. The cabinet, the gas inlet and the gas outlet are not shown in FIG. 5. After application of pressure to the sintering stack, the atmosphere in the cabinet was replaced with an oxidatively inert atmosphere of 5 vol % H₂ and 95 vol % N₂.

The sintering temperature was set to 835° C., and the temperature of the sintering stack 100 was increased by applying an alternating current from the power supply 102. The alternating current had a frequency of about 50 Hz, and the current was controllable at a voltage of about 380 V. The temperature profile was monitored using the thermocouples 103 and is shown in FIG. 6. FIG. 6 shows the recorded and set temperatures on the Y-axis, and the X-axis shows the number of log points for the process. Temperatures were recorded every 40 seconds, and each temperature measurement represents a log point in FIG. 6. Specifically, the temperature was set to increase to 230° C., i.e. close to the melting point of tin, and then held at 230° C. for about 5 minutes before increasing the temperature to the sintering temperature of 835° C. The sintering temperature was maintained about 1.5 hours before allowing the sintering stack 100 to cool. No active cooling was applied but the power supply 102 was set to a temperature of 150° C. allowing the sintering stack 100 to cool gradually. Thus, FIG. 6 shows the set temperature “TempSet”, the temperatures measured by the three thermocouples 103, “Temp1”, “Temp2” and “Temp3”, respectively. Temp1 was the temperature recorded by the thermocouple 103 at the middle conducting material 101, and Temp2 and Temp3 were the temperatures recorded by the other thermocouples 103. FIG. 6 also shows an upper temperature limit, “UTLTemp” and a lower temperature limit, “LTLTemp”. The upper temperature limit and the lower temperature limit were set for the process to indicate temperature values, which the temperature of process were not allowed to deviate from during the heating and the step of maintaining the temperature at the sintering temperature. As is evident from FIG. 6, all of Temp1, Temp2 and Temp3 remained close to the set temperature TempSet during the heating step and the step of maintaining the temperature at the sintering temperature. In particular, the recorded temperatures deviated only marginally from the set temperature. During the cooling of the sintering stack 100, the measured temperatures deviated from the set temperature profile, however, this deviation does not influence the result from the manufacturing method.

### Example 2

The friction elements manufactured in Example 1 were mounted in the brakes of a KTM 1290 Super Duke GT and a Honda CBR650FA motorcycle, and subjective evaluations of the friction elements of the disclosure compared to brakes fitted with commercial brake pads known as SBS-SI-90HH (HS) and obtained from SBS Friction A/S, Svendborg, Denmark. The subjective evaluations are summarised in Table 3, where “KTM” is the KTM 1290 Super Duke GT, and “Honda” is the Honda CBR650FA motorcycle, respectively, and “HS” is the SBS-SI-90HH (HS) brake pad, and “Ex. 1” the friction elements prepared in Example 1, respectively. The friction elements were rated in a range of parameters and given a subjective score in the range of 1 to 5 with 5 being the highest value.

TABLE 3
Subjective evaluation of friction element of the disclosure

| Evaluation category | KTM | Honda | KTM | Honda |
|---|---|---|---|---|
| Friction element | HS | HS | Ex. 1 | Ex. 1 |
| Brake power | 4 | 4 | 4 | 4 |
| Initial bite | 3 | 3 | 4 | 4 |
| Lever feel | 2 | 2 | 4 | 4 |
| Comfort | 4 | 3 | 4 | 4 |
| Recovery | 2 | 3 | 5 | 4 |
| Noise | 3 | 4 | 4 | 4 |
| Vibrations | 4 | 4 | 4 | 4 |
| Combined score | 3 | 3 | 4 | 4 |

As is evident from Table 3, the friction elements of Example 1 outperformed the commercial brake pads for both motorcycles.

### REFERENCE SIGNS LIST

1 Friction element
11 Friction material
12 Front end
13 Rear end
14 Mounting ring
2 Back plate
21 Connection surface
22 Protrusion
23 Trench
3 Wheel
31 Tire
32 Brake assembly
33 Rotor
4 Intermediary Friction element
41 Pre-Sintering puck
51 Sintering anode
52 Sintering cathode
100 Sintering stack
101 Plate of a conducting material
102 Power supply
103 Thermocouple

1. A method of manufacturing a friction element, the method comprising the steps of:
providing a back plate, the back plate having a connection surface comprising a plurality of protrusions;
providing a sintering composition comprising:
a friction modifying metal in the range of 0 wt % to 5 wt %;
a fibre component in the range of 1 wt % to 10 wt %;
metal phosphide in the range of 2.5 wt % to 12 wt %;
a lubricant in the range of 6 wt % to 23 wt %;
a filler in the range of 0 wt % to 5 wt %;
an abrasive in the range of 3 wt % to 20 wt %;
a processing aid in the range of 0.2 wt % to 2 wt %; and
iron to balance;
applying the sintering composition to the connection surface and shaping the sintering composition to form an intermediary friction element having a pre sintering puck on the back plate;
positioning one or more intermediary friction elements between a sintering carrier and a sintering vice plate with the back plate facing the sintering carrier and the pre sintering puck facing the sintering vice plate or with the back plate facing the sintering vice plate and the pre sintering puck facing the sintering carrier; and
simultaneously
applying a pressure between the sintering vice plate and the sintering carrier, the pressure being in the range of 10 kg/cm² to 200 kg/cm²;
increasing the temperature between the sintering vice plate and the sintering carrier to a sintering temperature in the range of 800° C. to 950° C.; and
maintaining at least one of the applied pressure and the sintering temperature for a sintering duration in the range of 1 hour to 10 hours to form a friction material on the back plate.

2. The method of manufacturing a friction element according to claim 1, wherein the sintering carrier is a sintering anode, and the sintering vice plate is a sintering cathode, and an electrical current is applied between the sintering cathode and the sintering anode to increase the temperature to the sintering temperature, and at least one of the applied electrical current, the applied pressure, and the sintering temperature is maintained for the sintering duration.

3. The method of manufacturing a friction element according to claim 2, wherein the temperature is increased to the sintering temperature without employing external heating.

4. The method of manufacturing a friction element according to claim 1, wherein the friction modifying metal has a melting point below the sintering temperature.

5. The method of manufacturing a friction element according to claim 1, wherein the friction modifying metal is present in the range of 1 wt % to 1.5 wt % of the sintering composition.

6. The method of manufacturing a friction element according to claim 1, wherein the sintering composition comprises metal phosphide in the range of 4 wt % to 12 wt %;

7. The method of manufacturing a friction element according to claim 1, wherein the sintering composition comprises:
a fibre component in the range of 1 wt % to 10 wt %;
metal phosphide in the range of 2.5 wt % to 12 wt %;
a lubricant in the range of 6 wt % to 23 wt %;
a filler in the range of 0 wt % to 5 wt %;
an abrasive in the range of 3 wt % to 20 wt %;
a processing aid in the range of 0.2 wt % to 2 wt %; and
iron to balance.

8. The method of manufacturing a friction element according to claim 1, wherein the step of shaping the sintering composition to form an intermediary friction element comprises subjecting the sintering composition on the back plate to a pressure in the range of 300 kg/cm² to 3300 kg/cm².

9. The method of manufacturing a friction element according to claim 8, wherein the shaping has a shaping duration in the range of 10 seconds to 10 minutes.

10. The method of manufacturing a friction element according to claim 1, wherein the protrusions extend from the connection surface to have a length in the range of 50% to 80% of the thickness of the friction material, and wherein the protrusions are angled in the connection surface to have angles in the range of 60° to 120°.

11. The method of manufacturing a friction element according to claim 2, wherein a plurality of intermediary friction elements is positioned in two or more layers in a sintering stack, with each layer being separated by a plate of a conducting material.

12. The method of manufacturing a friction element according to claim 2, wherein the electrical current is an alternating electrical current at a voltage in the range of 0 to 400 V and a current in the range of 0 A to 300 A.
